(19) United States
(12) Patent Application Publication
(10) Pub. No.: US 2016/0321875 A1
(43) Pub. Date: Nov. 3, 2016

(54) VIDEO POKER MACHINE WITH BONUS TRIGGER

(71) Applicant: MTD Gaming, Inc., Billings, MT (US)

(72) Inventor: Mike Tessmer, Bozeman, MT (US)

(21) Appl. No.: 14/702,684

(22) Filed: May 2, 2015

(51) Int. Cl. G07F 17/32

(52) U.S. Cl. CPC G07F 17/3293; G07F 17/3244

(57) ABSTRACT

A method, apparatus, and computer readable storage to implement a bonus trigger mechanism which determined when a free bonus game (or multiple free games) is awarded to the player. A random determination determines whether the game initially qualifies for the bonus round. The qualifying can be displayed in numerous ways, such as adding tags (indicia) to symbols which are used for game-play. In order that the player actually receive the free bonus round(s) the player also has to win the underlying game.

### BACKGROUND OF THE INVENTION

1. Field of the Invention

The present general inventive concept is directed to a method, apparatus, and computer readable storage medium directed to a video poker machine which can trigger a bonus round.

2. Description of the Related Art

Gaming machines are a billion dollar industry. Bonus rounds are a common add-on to amusement devices offering video poker, slot machines, or other games. It is known to trigger a bonus round based on a predetermined hand in a poker game such as a 4 of a kind.

One deficiency of this paradigm is if a player receives the 4 of a kind, the players already expect to win a nice award in the game thereby removing some of the “surprise” factor and excitement while playing a wagering amusement device.

What is needed is a more exciting mechanism to trigger a bonus round.

### SUMMARY OF THE INVENTION

It is an aspect of the present invention to provide an improved bonus round trigger.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating the prior art game of video poker;

FIG. 2 is a drawing of one example of a video poker machine that can be used to implement methods herein, according to an embodiment;

FIG. 3 is a drawing illustrating numerous apparatuses that can play the game described herein, according to an embodiment;

FIG. 4 is a flowchart illustrating an exemplary method of implementing a video poker game with a bonus trigger, according to an embodiment;

FIG. 5 is an example output of the game after an initial deal, according to an embodiment;

FIG. 6 is an example output of the game after the player indicates the hold cards, according to an embodiment;

FIG. 7 is an example output of the game after the draw, according to an embodiment;

FIG. 8 is a drawing of one type of bonus round that can be offered, according to an embodiment;

FIG. 9 is a drawing illustrating how the bonus trigger mechanism can also be applied to a slot machine game, according to an embodiment;

FIG. 10A is a block diagram illustrating exemplary hardware that can be used to implement the game described herein, according to an embodiment; and

FIG. 10B is a network diagram showing a network structure for a social networking web site and players, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a video poker game with a bonus round (also referred to as bonus game). A bonus round qualifier is randomly triggered on the deal but the bonus round itself won't be initiated unless the player wins the current hand. If the player loses the current hand, then the player does not enter the bonus round.

Video poker is a well-known game in the art, for example see U.S. Pat. No. 6,569,014, which is incorporated by reference here in its entirety.

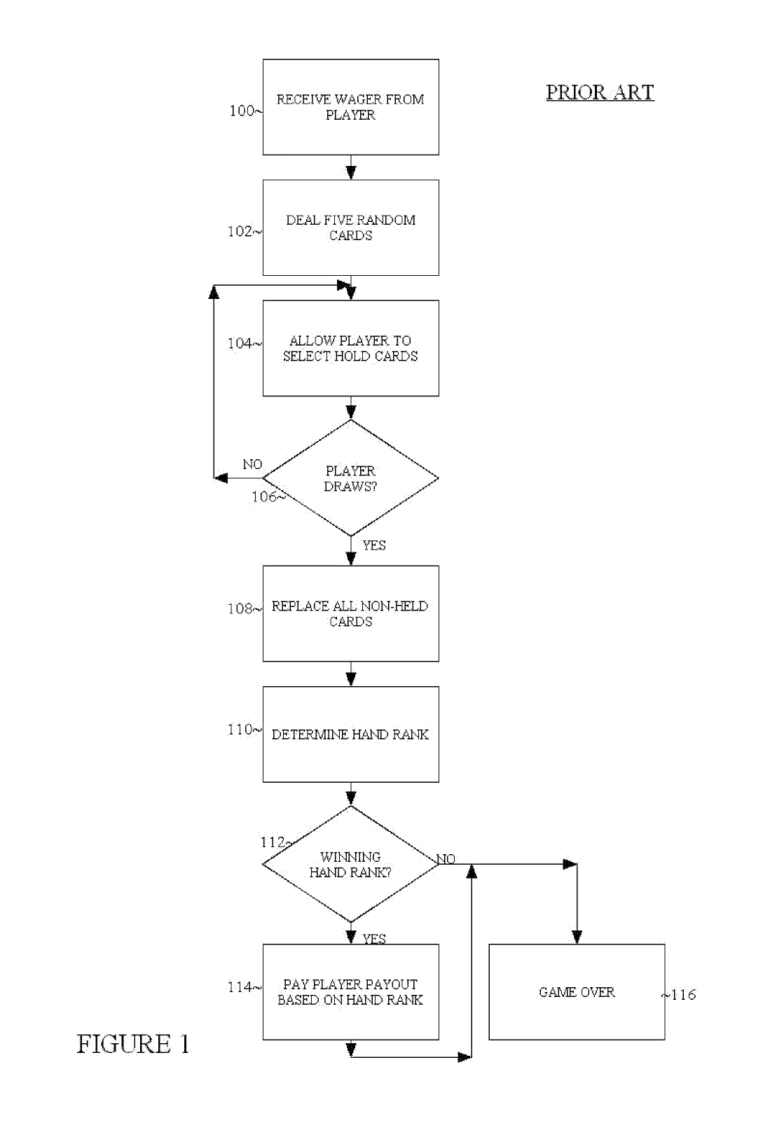

FIG. 1 is a flowchart illustrating the prior art game of video poker. The goal is for the player to form the highest ranking poker final hand the player can make, wherein if the final hand is one of a predetermined number of winnings ranks, the player is paid for the rank of the final hand using a paytable.

The game can operate as follows. In operation 100, the machine receives a wager from a player. This is typically done by the player indicating to the machine how many credits he or she wants to bet (using buttons) and then presses a button to indicate that he or she wishes to begin a new game, upon which the number of credits bet is deducted from the player's credit meter. Initially, the player can make a cash deposit (or use a ticket/voucher, or electronic form of payment) in order to fund the credits in the machine.

From operation 100, the method proceeds to operation 102, which deals five random cards to the player. This can be considered the player's initial hand. Typically, a single standard 52 card deck is used, although in other variations, other types of decks can be used as well (e.g., decks with one or more wildcards). The five cards are typically dealt face up.

From operation 102, the method proceeds to operation 104, which allows the player to select the player's hold cards in the initial hand. The player's hold cards are cards which the player wishes to keep. Cards which are not hold cards are considered “discard cards.” The player can indicate which of the cards are hold cards by touching the desired hold cards (on a touch-screen machine) or by pressing buttons. The player can also touch a card with “hold card” status and the status can be changed to no longer be a hold card.

From operation 104, the method proceeds to operation 106, which determines whether the player draws. In order to draw, the player can press a draw button which initiates a draw. If the player does not draw, the player is free to continue to change the desired hold cards (in operation 104) until the player is satisfied with his or her choice.

Once the player draws in operation 106, the method proceeds to operation 108, which replaces all the discard cards in the initial hand (cards which are not indicated as hold cards) with newly dealt cards from the virtual deck in order to form a final hand.

From operation 110, the method proceeds to operation 112, which determines a hand rank of the final hand. This can be done by comparing the cards in the final card to determine if they meet a particular defining criteria. Table I below is an exemplary video poker paytable which comprises a list of video poker hand ranks, although it can be appreciated that different variants of video poker can use different hand ranks and payouts.

TABLE I

| Hand | payout |
|---|---|
| Royal Flush | 250 |
| Straight Flush | 50 |
| Four of a Kind | 25 |
| Full House | 9 |
| Flush | 6 |
| Straight | 4 |
| Three of a Kind | 3 |
| Two Pair | 2 |
| Jacks or Better | 1 |
| Anything else | 0 |

From operation 112, the method proceeds to operation 112 which determines if the final hand is a winning hand rank. A winning hand rank is a rank on the paytable being used that has a payout greater than 0.

If the final hand rank is a winning rank, then the method proceeds to operation 114, which pays the player based on the hand rank. The payout is determines using a respective entry in the paytable which corresponds to the winning final hand rank multiplies by the number of coins bet. The payout is typically made in the form of credits that can be cashed out for real coins, or a ticket redeemable for cash at a kiosk, when the player wishes. From operation 114, the method proceeds to operation 116, wherein the game ends.

If the final hand rank is not a winning rank, then the method proceeds to operation 116, wherein the player is not paid a payout and the game ends. Of course, the player is free to begin a new game (by pressing appropriate buttons) and start again at operation 100 if the player so wishes.

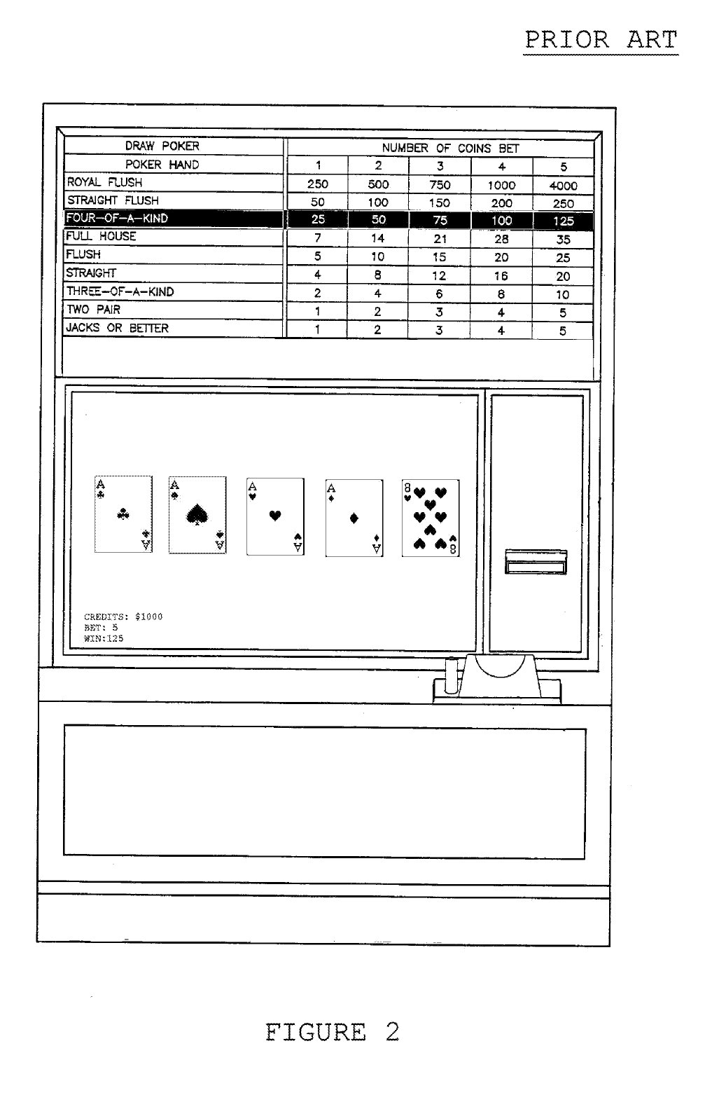

FIG. 2 is a drawing of one example of a video poker machine that can be used to implement methods herein, according to an embodiment. Of course other types of machines can be used as well, including playing over the internet using a personal computer.

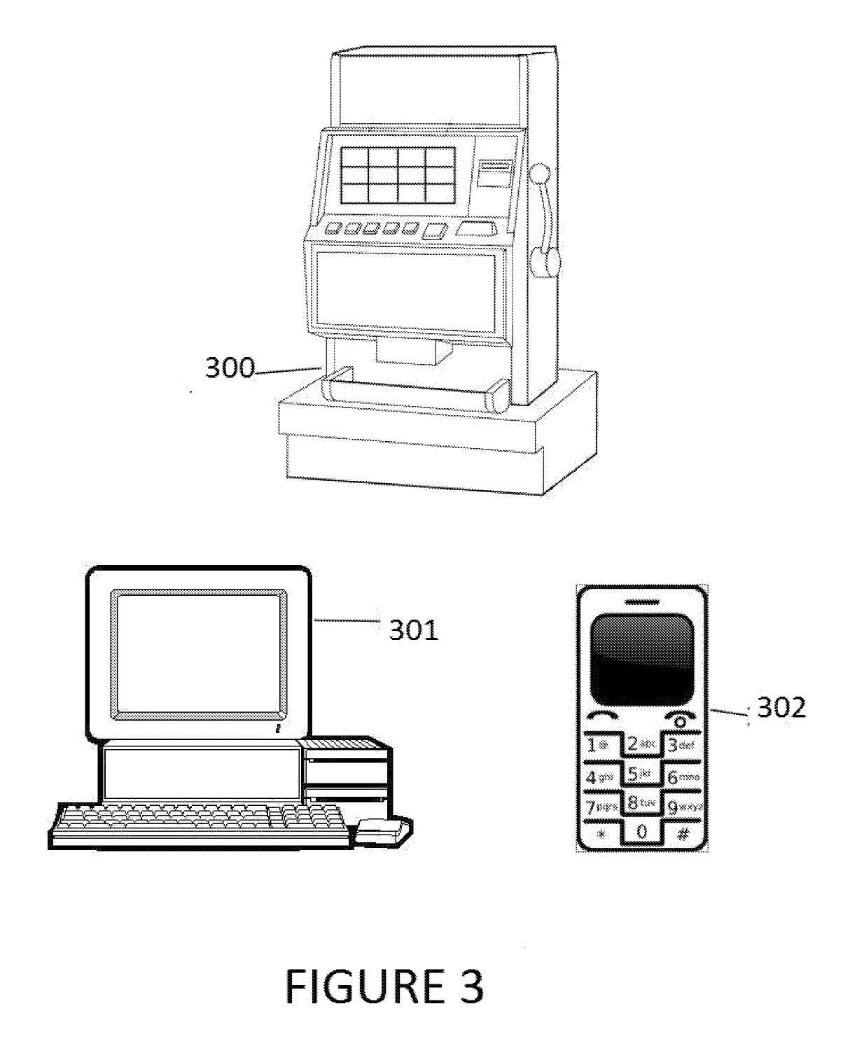

FIG. 3 is a drawing illustrating numerous apparatuses that can play the video poker machine game described herein, according to an embodiment.

The game described herein can be played on an electronic gaming machine 300 that can found in brick and mortar casinos or other venues such as internet cafes, etc. Cash (or cashless vouchers) can be inserted into the machine 300 using a bill acceptor which credits the machine with a respective amount of credits which can then be used to play the game, and winnings are paid out in the form of credits which can then be cashed out for cash or a cashless voucher (ticket) that can be redeemed for cash. The game described herein can exist on a software module pre-installed on the slot machine 300 or can be downloaded to the electronic gaming machine 300 from a central remote server.

The game described herein can also be played on a computer 301 such as a personal computer, laptop, etc. The game can be downloaded to the computer 301 and stored locally on the computer 301. Alternatively, the computer 301 can have an internet connection (not illustrated) so that the game can be served from a remote location and player and displayed on the computer 301. For example, the game can be played on an online casino (wherein the player can wager for real money using a credit card or other deposit method, where legal) in which the results are determined on a remote server and transmitted to the computer 301 so that the computer displays the results. The game can also be played on the computer 301 for “casual play” on a social networking site (e.g., FACEBOOK, MYSPACE, etc.) wherein the game software can be launched from within the social network site itself “Casual play” is where the game can be played not for real money but for credits which typically have no cash value, but can have other benefits to the player.

The game described herein can also be played on a cell phone 302 or any other type of portable device, such as a tablet computer, etc. The portable device can implement any of the paradigms described above with respect to the computer 301 (e.g., online casino, social networking site, etc.)

An inventive concept herein relates to a bonus round trigger which is only triggered when the player (game) qualifies based on a random determination on/after an initial deal and the player wins the game (gets a paying hand). If the player does not qualify for the bonus round or the player does not win the hand then the player does not proceed to the bonus round.

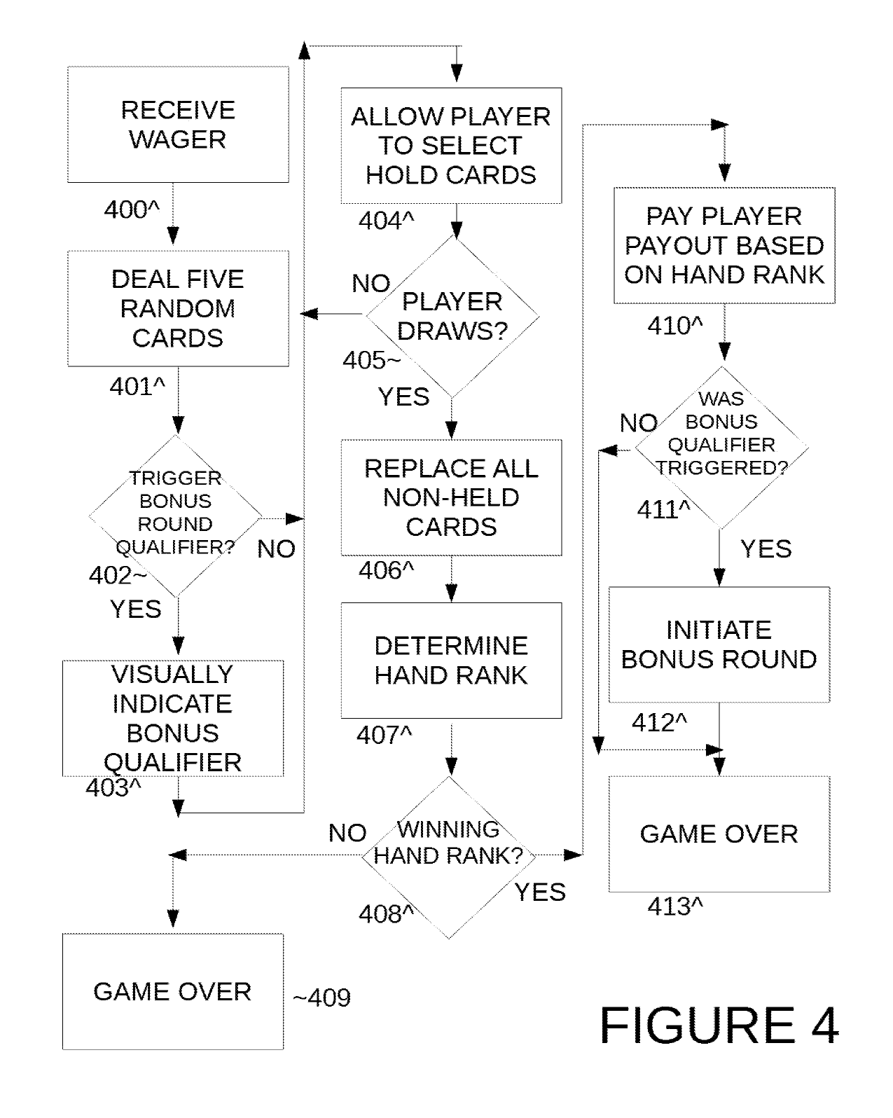

FIG. 4 is a flowchart illustrating an exemplary method of implementing a video poker game with a bonus trigger, according to an embodiment.

The method begins with operation 400, which receives a wager from the player. The player would initially have to fund the machine in one of numerous ways (e.g., by inserting a cashless ticket into a bill validator, inserting currency (cash) into the bill validator, inserting coins, inserting or swiping a card which identifies a payment account controlled by the player, etc. Once the player has funded the machine, then the player's credit meter reflects the amount that the player has deposited (e.g., if the player inserts a $100 bill then the credit meter will reflect 100 credits assuming each credit is worth one dollar). Once the credit meter is funded, the player makes individual wagers on individual games, each individual wager is deducted from the player's credit meter. Of course, if the credit meter is lower than the individual wager amount, then the game will not initiate.

From operation 400, the method proceeds to operation 401 which deals (displays) to the player five random cards. The computer programming maintains a virtual deck of 52 decks and the cards dealt are taken randomly from this virtual deck.

From operation 401, the method proceeds to operation 402, which determines whether to trigger the bonus round qualifier. The bonus round qualifier can be triggered by a pure random determination, for example if a 1 in X random event occurs (where X is a predetermined number greater than 1) then the bonus round qualifier is triggered. The bonus round qualifier does not guarantee entry into the bonus round, it only qualifies the player for the bonus round. This means that if the player is qualified for the bonus round, the player still has to win the current game (get a payout greater than zero) in order to then enter bonus round. The values of the cards (e.g., rank and suit) are independent of whether the bonus round is qualified for or not.

In a further embodiment, the bonus round qualifier can also be triggered (in addition to the random determination discussed above) if the initial hand is a predetermined initial hand. For example, if the player's initial hand is any pair then the bonus round qualifier is also triggered (regardless of bonus tags). Any predetermined set of hands can be used to award the bonus qualifier (e.g., any pair, a specific pair (e.g., pair of aces), a straight, all red cards, or any predetermined set of initial cards). The predetermined set of initial hands can comprise losing hands such as four to a royal. In this embodiment the player gets two opportunities to qualify for the bonus round, one if the player qualifies randomly (e.g., based on receiving bonus tags) and also if the player's initial hand is a predetermined initial hand (irrespective of any bonus tags).

From operation 402, the method proceeds to operation 403, which visually indicates to the player on the electronic output device that the player has qualified for the bonus round. This can be done in numerous ways. For example, an indicator (a “tag”) on at least one of the dealt cards can have a qualifier marker indicating that the bonus round has been qualified for. The tag can be for example, a background color of the card, a special symbol on the card, a border around the card, or any graphic representation that indicates that the player has qualified for the bonus qualifier such as words that pop up on the screen that say “any win triggers bonus”. Once the bonus round has been qualified for, the player cannot lose the qualifier. If the player discards card(s) that have the qualifier marker, it would not cause the player to lose the bonus round qualifier. Alternatively, a simple message can pop up that is not on any of the cards stating that the bonus round has been qualified for.

In one embodiment, if the player receives at least one bonus tag (or visual indication that the bonus qualifier has been earned) then the player receives the bonus qualifier. In another embodiment, the number of cards with tags on them determine whether the player qualifies for the bonus round and how many bonus rounds (also referred to as bonus games) the player will receive. For example, Table I below is an example of a number of tags (also referred to as “bonus tags”) displayed and what effect the tags have (e.g. how many free bonus games the player gets to play which give the player to win more credits). Note that each card will either have zero or 1 tag but no more than 1.

TABLE I

| Number of tags | result |
|---|---|
| 5 | bonus qualifier with 88 bonus games |
| 4 | bonus qualifier with 18 games |
| 3 | bonus qualifier with 8 games |
| 2 | no bonus qualifier |
| 1 | no bonus qualifier |
| 0 | no bonus qualifier |

Thus, if all five of the player's initial cards have bonus tags then the player receives the bonus qualifier and if the player reaches the bonus (the player has a winning hand at the end of the game) then the player would receive 88 free bonus games.

Note that if the game does not qualify for a bonus round, then this fact can be indicated to the player either by a message to this effect (e.g., “no bonus round qualified for” or simply no message/indication at all (the absence of the bonus tag(s) (or other qualifying indicia) indicates to the player that they did not qualify for the bonus round).

From operation 403, the method proceeds to operation 404, which allows the player to select hold cards. The player would typically touch the cards the player wishes to hold on the touch-screen (or use buttons on the machine). There is also a “draw” button (either real of virtual) that the player can press in order to draw (discard the cards which are not held by the player and draw replacement ones). When the player presses the “draw” button then the method proceeds to operation 406. Otherwise, the method returns to operation 404 which continues to allow the player to select his/her hold cards.

When the player presses the “draw” button then the method proceeds to operation 406, which replaces all of the non-held cards. The cards which are not indicated by the player to be held are discarded (removed from the display) and an equal number of new replacement cards are dealt from the virtual deck (cards discarded cannot now be dealt from the virtual deck). Note that even if the player discards a card that has the bonus qualifier tag on it, the player would not lose the bonus qualifier (once the bonus has been qualified for it cannot be lost). Thus, the player will not be deterred from discarding card(s) with the bonus tag because the player will not lose any bonus tags (e.g. replace cards to replace a card with a bonus tag will also have the bonus tag). Note however that receiving the bonus qualifier may affect the player's strategy as the player may wish to maximize his/her chances of ending the game with a winning hand versus playing to maximize the player's return. Replacement cards (also known as “draw cards”) will not have the qualifier tag on them, as whether the bonus qualifier has been earned is revealed to the player on the deal not the draw.

In an alternative embodiment, contrary to the above described embodiment, additional bonus tags can be awarded on the draw (replacement cards) as well. For example if the player discards a card without a bonus tag, then its replacement card could have a bonus tag (determined randomly) thereby increasing the number of bonus tags the player has earned.

From operation 406, the method proceeds to operation 407, which determines the hand rank (the highest rank hand using the five displayed cards).

From operation 407, the method proceeds to operation 408 which determines whether the hand rank is a winning hand rank (has a payout greater than zero). If not, then the hand is a loser and the method proceeds to operation 409 wherein the game ends. The player is free to initiate a brand new game which returns to operation 400.

If in operation 408, the player has a winning hand rank then the method proceeds to operation 410 which pays the player a respective payout on the paytable being used based on the hand rank. The payout is typically paid by increasing the amount of credits on the machine (which the player can cash out for at any time by pressing an appropriate button).

From operation 410, the method proceeds to operation 411, which determines whether the bonus round qualifier was triggered (determined in operation 402). If not, then the method proceeds to operation 413 which ends the game. The player is free to initiate a brand new game which returns to operation 400.

If in operation 411, the bonus round qualifier was triggered, then the method proceeds to operation 412 which initiates the bonus round. After the bonus round is completed, then the method proceeds to operation 413 which ends the game. The player is free to initiate a brand new game which returns to operation 400.

In an alternative embodiment, in operation 411, if the player receives a particular win then this would override the requirement that the player had to receive the bonus qualifier (in operations 402/403). For example, if the player wins with three of a kind, then the player would enter the bonus round (proceed to operation 412) even though the bonus round qualifier was not triggered in this game. The winning hand that would automatically enter the bonus round (without the need to receive the qualifier) can be any winning hand in a set of predetermined hands (e.g., three aces, four of a kind, straight flush, etc.) In a further embodiment, non-winning (losing) hands can also be included in the set of predetermined hands that automatically enter the bonus round. Hands that automatically enter the bonus round can be limited to final hands, initial hands, or can be applied to both initial and final hands.

In another embodiment, in operation 411, a specific win (or wins) may be required (as opposed to any win) in addition to getting the bonus qualifier in order to initiate the bonus round. For example, in the previous described embodiments, any win (any paying hand) would initiate the bonus round (along with having the bonus qualifier). In this embodiment, only certain winning (paying) hands will initiate the bonus round (along with having the bonus qualifier). For example, all wins of a ‘pair of jacks or better’ would not entitle the player to proceed to the bonus round while all other wins would. In this embodiment, there is a subset of all winning (paying) hands that would initiate the bonus (when the bonus qualifier is received) while the remaining winning (paying) hands not in the subset would not initiate the bonus (when the bonus qualifier was received).

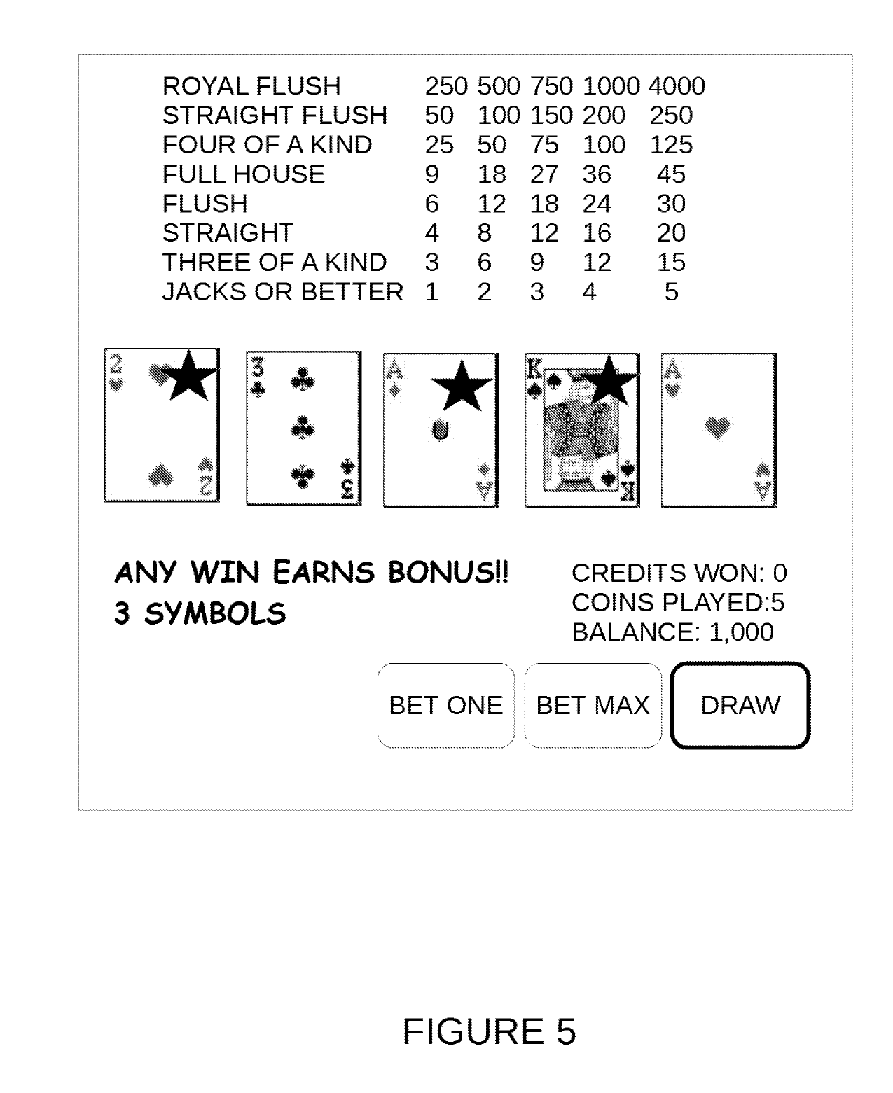

FIG. 5 is an example output of the game after an initial deal, according to an embodiment.

After the player places the initial wager (operation 400), then the machine deals the five random cards which are the player's initial hand (operation 401). Note that bonus tags are present on the first, third, and fourth cards. Note that in this embodiment, the cards themselves in the virtual deck are not tagged with bonus tags. Instead, a bonus tag appears on any card with a fixed probability (e.g., each card has a 10% chance of getting a bonus tag). In another embodiment, the cards in the virtual deck can be randomly tagged before the deal, for example ten random cards in the virtual deck are virtually tagged so that when these cards are dealt the bonus tag is visible/awarded to the player. In another embodiment, a set of bonus tags is awarded with a predetermined probability, for example, there is a 50% that no bonus tags are present, a 20% chance that one bonus tag is present (and the tagged card is selected randomly), a 15% chance that two bonus tags are present (and the tagged cards are selected randomly), a 10% chance that three bonus tags are present (and the tagged cards are selected randomly), a 4% chance that four bonus tags are present (and the tagged cards are selected randomly), and a 1% chance that all five (the maximum) bonus tags are present. Any type of paradigm that awards bonus tags on the cards can be used. Of course the probabilities of earning bonus tags has to be computed so that the overall payback percentage for the machine is in an acceptable range for the game to remain profitable for the house (under 100% and typically over 85%).

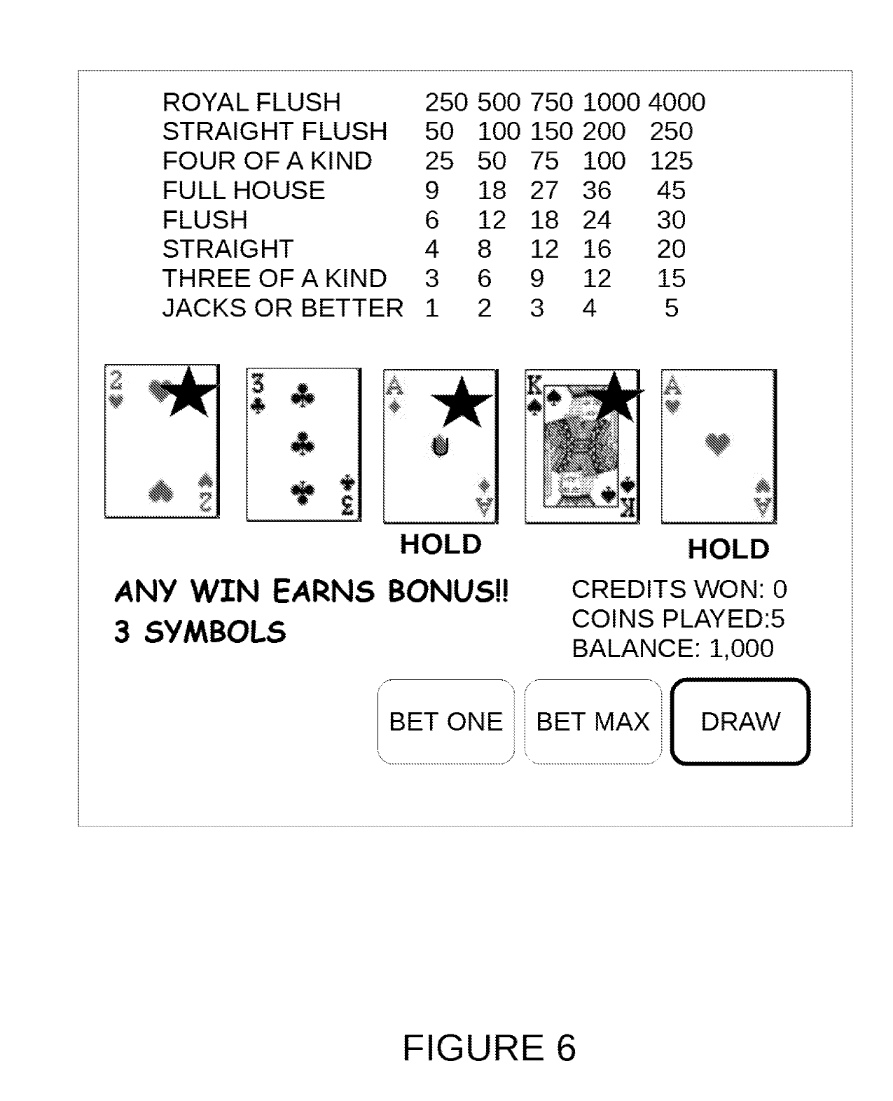

FIG. 6 is an example output of the game after the player indicates the hold cards, according to an embodiment.

The player touches the cards the player wishes to hold (hold cards) in operations 404-405. If the player changes his/her mind, then the player can touch a hold card to change its status back to a non-hold (discard) card. The hold cards are the ones that will remain in the player's hand while the non-hold cards will be replaced with random cards from the virtual deck. The player is not concerned about losing the bonus tags since they will remain on any replacement cards in the same card position. In this example, the player properly holds the pair of aces and discards the remaining cards (by not selecting them as hold cards). When the player wants to initiate the draw (replacement of non-hold cards) the player presses the “draw” button (the bet one and bet max buttons are inactive at this time).

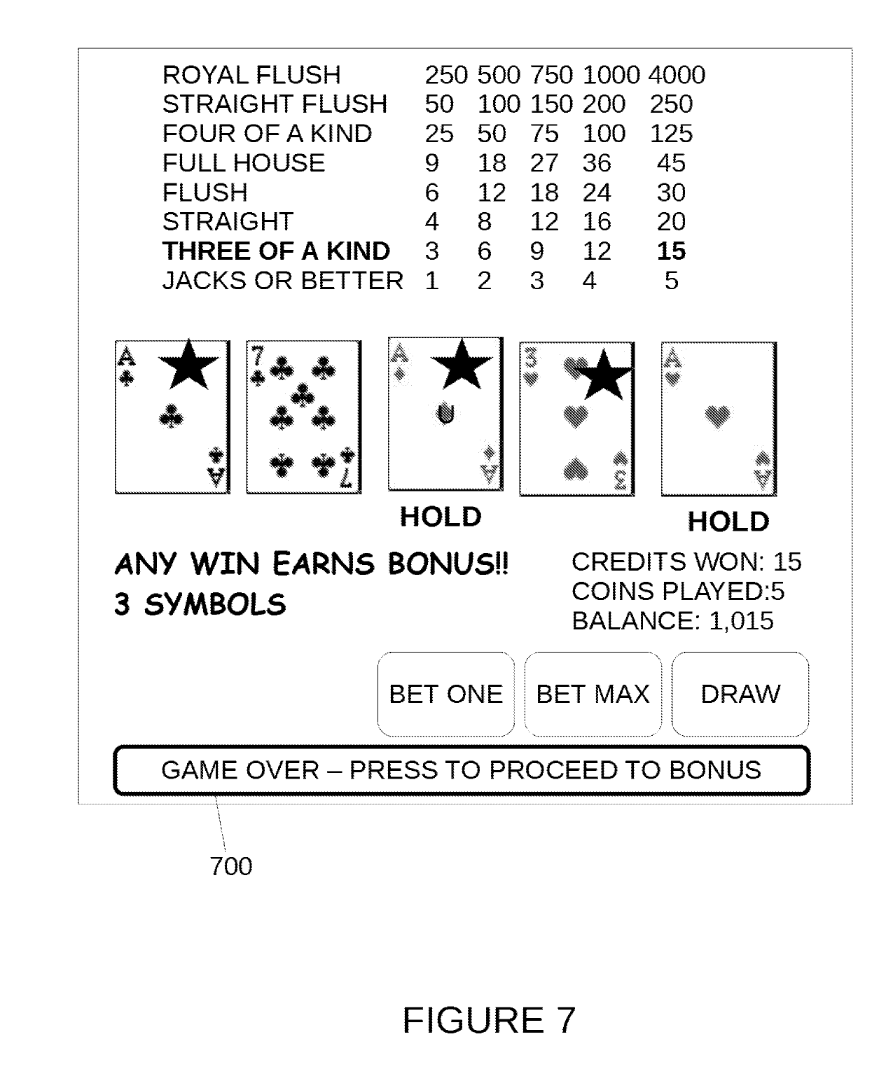

FIG. 7 is an example output of the game after the draw, according to an embodiment.

Once the player presses the “draw button”, the non-hold cards are removed and replaced with newly dealt random cards (operation 406). Note that the three bonus tags remain in the same positions even on the cards that were discarded (replaced). The player now has three aces (three of a kind) and is paid (operation 410) 15 coins (since the player bet 5 coins) according to the paytable. The player also has the three bonus tags (it typically does not matter which cards have the bonus tags) and the player can now proceed to initiate the bonus games (operation 412) by pressing the bonus button 700.

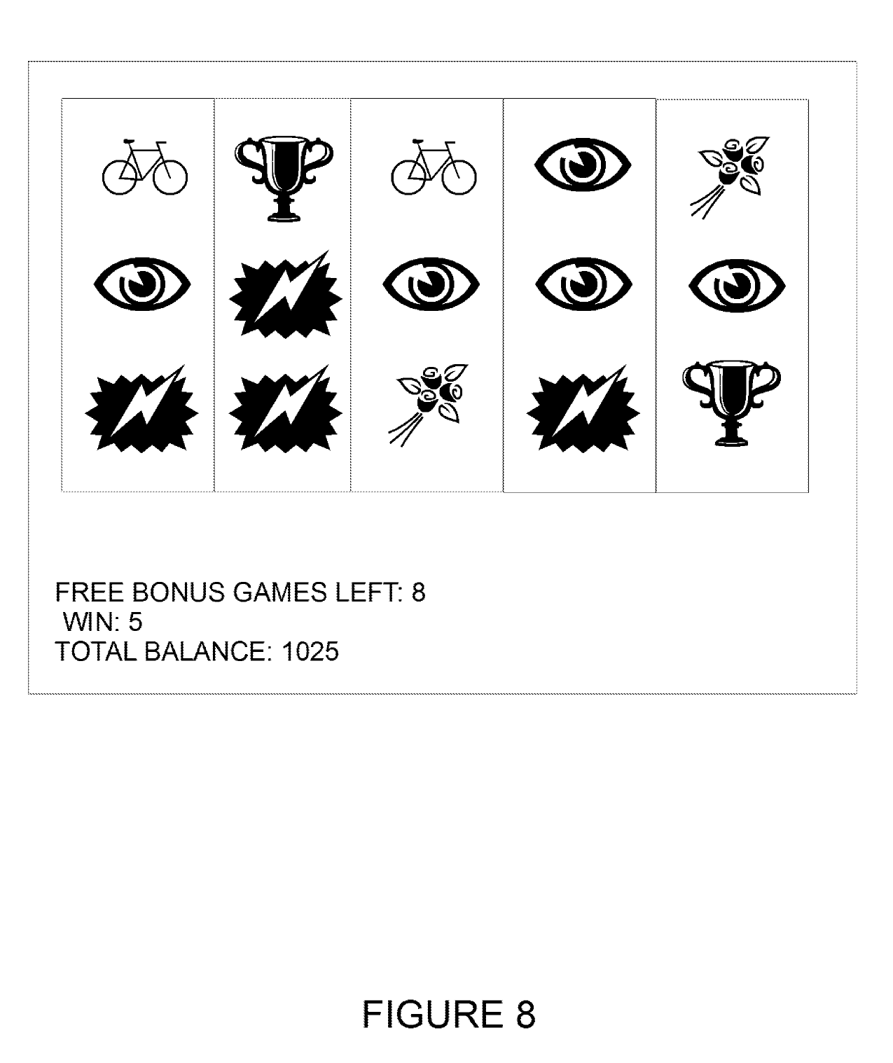

FIG. 8 is a drawing of one type of bonus round that can be offered, according to an embodiment.

A slot machine game spins reels comprising symbols (e.g., there can be 32 symbols per reel or any other number). Illustrated in FIG. 8 is a five reel slot game, note that three symbols from each vertical reel are visible at any one time. Predetermined paylines can be used (for example, a payline can be all symbols in the middle row, all symbols in the upper row, all symbols in the lower row, etc.) to select which symbols that are displayed are utilized in a combination. The reels will start and then stop spinning on a random position, the combinations on the paylines are determined (e.g., all five symbols on the top row) which are then compared to a predetermined paytable (comprising different combinations and respective payouts). For example, Table II below illustrates one example paytable that can be used for such a slot machine game. Of course Table II is simply one example and any other payout structure can be used, along with any type of symbols and any reel mapping.

TABLE II

| Combination | payout |
|---|---|
| 5 eyes | 1000:1 |
| 4 eyes | 500:1 |
| 5 identical symbols (not eyes) | 250:1 |
| 4 identical symbols (not eyes) | 100:1 |
| 3 identical symbols | 50:1 |
| Two trophies | 25:1 |
| Two lightning bolts | 10:1 |
| One bicycle | 2:1 |
| All others | 0 |

If the player earned one free bonus game then the reels would spin once and if the player earned an award it would be awarded to the player (the player has already been awarded the award for achieving a winning payout in the video poker game). If the player earned more than one free bonus game (e.g., 10 free bonus games), each of the bonus games would be played in succession with not wager/payment required by the player. All of the awards are accumulated and awarded to the player.

Note that any other type of bonus round can be offered as well. For example another type of bonus round would be a stud poker bonus round in which the player is presented with 52 cards face down (along with 2 wild cards and 4 “free game cards”). The player picks five random cards and then wins a payout based on a paytable using the five cards picked. A free game card would award the player an additional bonus round.

It can be appreciated that any type of visual game can be utilized as the bonus round/game. The bonus rounds give the player a chance to win more awards (credits) without have to pay anything extra, thereby generating excitement and accomplishment for the player.

While the methods described herein have been described with respect to video poker, it can be appreciated that all of the same methods/features described herein can also be applied to slot machine games as well.

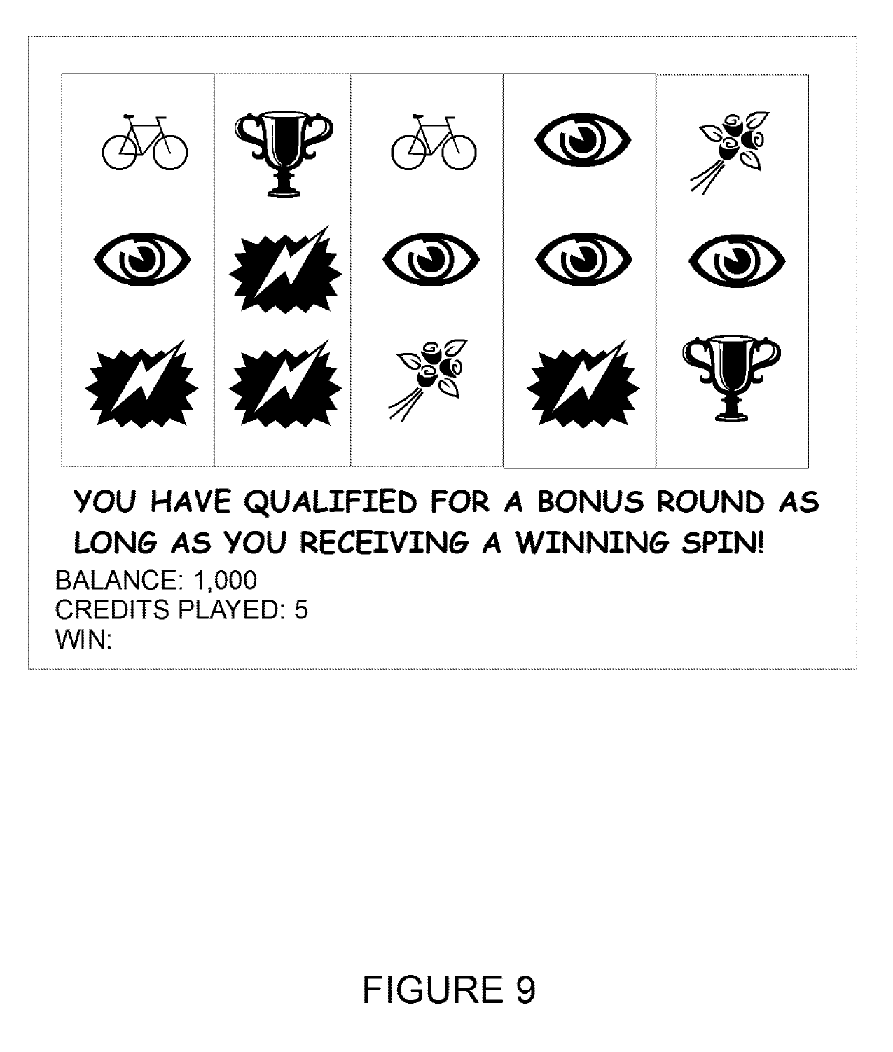

FIG. 9 is a drawing illustrating how the bonus trigger mechanism can also be applied to a slot machine game, according to an embodiment.

In a five reel slot game (or any number of reels), the player can randomly qualify for the bonus round in any manner as described herein. For example, a purely random determination can display a bonus qualify message as illustrated in FIG. 9. Bonus tags on the slot machine symbols can also be utilized in the same manner as described herein with respect to video poker. The bonus qualify message can be displayed before the reels spin (but after the wager is placed) or while the reels are spinning. Once the reels stop spinning it is determined whether the spin has a payout greater than zero which would trigger the bonus round (if the original game qualified for the bonus).

In a further embodiment, instead of allowing any win (payout greater than zero) to initiate the bonus game (assuming the player qualified for the bonus round), only certain wins would trigger the bonus round. For example, a win on a specific payline would trigger the bonus round; or a win that is greater than a predetermined amount would trigger the bonus round; or particular combinations trigger the bonus round (e.g., five cherry symbols, etc.).

In yet a further embodiment, the bonus round would be triggered on qualifying for the bonus and any win or getting a specific win (e.g., a combination in a predetermined set of combinations such as five cherries, etc.) For example, the player would be entitled to initiate the bonus round by getting the bonus qualifier and getting any winning spin (combination). The player would also be entitled to initiate the bonus round if the player does not get the bonus qualify but then gets a particular combination in a predetermined set of combinations. Thus, the player gets a “second chance” to enter the bonus round.

In a further embodiment, different magnitude wins (or different combinations) would trigger different amounts of bonus rounds in conjunction with the bonus qualifier. For example a win of under 10 coins would trigger 9 free bonus rounds, a win of 10 coins to 100 coins would trigger 50 free bonus rounds, and a win over 100 coins would trigger 100 free bonus rounds.

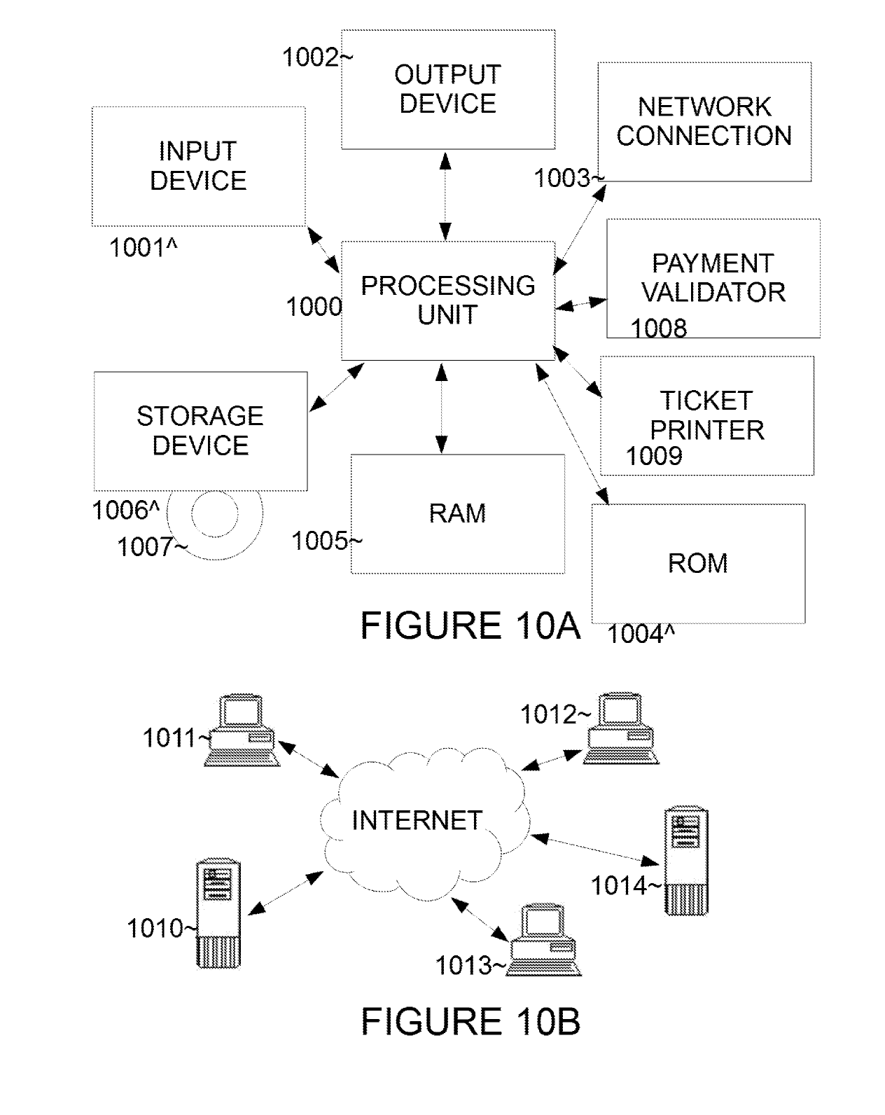

FIG. 10A is a block diagram illustrating exemplary hardware that can be used to implement the game described herein, according to an embodiment. The hardware in FIG. 10A can be used to implement a computer implementing the game described herein and/or a server that is serving the game to a computer which is displaying the game to a player.

A processing unit 1000 can be a microprocessor and associated structure (e.g., bus, cache, clock, etc.) which can be connected to an input device (e.g., touch-screen, keyboard, mouse, buttons, etc.), and an output device (e.g., touch-screen, CRT, monitor, etc.) The processing unit 1000 can also be connected to a network connection 1003 which can connect to a computer communications network such as the Internet, Wi-Fi, LAN, WAN, etc. The processing unit 1000 can also be connected to a ROM 1004 and a RAM 1005 as used in the art. The processing unit 1000 can also be connected to a storage device 1006 which can be nonvolatile storage device (e.g., BLU-RAY drive, CD-ROM drive, hard drive, EPROM, etc.) A computer readable medium 1007 (e.g., BLU-RAY disc, CD-ROM, hard disc, etc.) can be read by the storage device 1006 and can store programs and assets that can cause the processing unit 1000 to perform any of the methods described herein. The ROM 1004 and RAM 1005 can also be loaded with instructions that can cause the processing unit 1000 to perform any of the methods described herein.

The processing unit 1000 can also be connected to a payment validator 1008. The payment validator can be a bill acceptor which accepts currency, identifies it as being valid (typically by using an optical scanner), and then credits the inserted bill amount to the machine (for example inserting a $10 bill will credit the machine with $10 in credits). The bill acceptor can also accept cashless tickets as part of a “ticket-in-ticket-out” system, in which tickets (cashless vouchers) have cash value and can be inserted into the payment validator 1008. The validator 1008 validates the ticket (typically be optically scanning a bar-code) and crediting the machine with the respective amount of credits. The payment validator 1008 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for playing the slot machine. If such a card is used, then the player can optionally enter (using a keypad) an amount the player wishes to withdraw from the account associated with the card to credit to the slot machine.

The processing unit 1000 can also be connected to a ticket printer 1009 which can print tickets (cashless vouchers). When the player cashes out on the slot machine (indicated to the machine that the player wishes to cash out and terminate by, typically by pressing a button), a ticket is printed by the ticket printer 1009 which carries the amount of credits left on the machine. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is.

FIG. 10B is a network diagram showing a network structure for a social networking web site and players, according to an embodiment. The online game which awards and stores virtual points can also be accomplished by the system illustrated in FIG. 10B.

A computer communications network (such as the Internet) can be used to connect a host server 1010 which can host and serve a social networking site. Note that while FIG. 10B shows only one server as the host server 1010, the host server 1010 can encompass numerous servers all cooperating with each other (whether in the same physical location or not). The host server 1010 communicates with players 1011, 1012, 1013 through the Internet (or other computer communication network) and can implement any of the methods herein by executing computer code programmed accordingly. Game server 1014 can also implement all games and methods described herein on the site by executing computer code programmed accordingly. The game server 1014 is connected to the Internet and can communicate with all of the players 1011, 1012, 1013 directly or indirectly through the social networking site hosted by the host server 1010. The game server 1014 can cooperate with the host server 1010 so that the games run on the game server 1014 can be integrated into the social networking site hosted by the host server 1010. The game server can also be optional and all of the games can be also hosted on the host server 1010, whereby the integration of the games served/hosted by the game server 1014 will appear embedded in the social networking site hosted by the host server 1010 such that players would typically not realize (or care) that multiple servers are cooperating in order to play games on the social networking site. All of the communications described herein can be effectuated using such a network configuration. Typically, the communications are effectuated on the social networking site itself, thus the players 1011, 1012, 1013 should be logged into the social networking site in order to participate herein, although logging in is not required (e.g., communications can be transmitted using other methods, such as email, IRC chat, instant message, etc.) The host server 1010 can communicate with any of the devices illustrated in FIG. 3.

All components herein can be distributed across different such components as needed. For example, a single server as mentioned herein can be distributed across numerous different servers and locations. A processor (or processing unit) can also be distributed across multiple processors in a same or different computer (at a same or different location). The electronic components described herein represent an abstraction but it can be appreciated that the computer systems implementing the methods herein can be more numerous and interconnected than illustrated herein.

If a player is playing the game described herein on a social networking site or other type of hosted environment, then the player's computer would cooperate with the social networking server in order to present the game to the player. The player's computer would perform the instructions necessary to display the game while the remote server can determine the results (e.g., the final arrangement) and communicate this result via the Internet to the player's computer so that the player's computer can accurately display the result. The remote server may track and account for all credits wagered and won/lost while the player's computer can display the amount of credits owned or won at the direction of the remote server so the player cannot tamper with these amounts. All games described herein are considered to be played on the site described herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All features described herein (including all documents incorporated by reference) can be combined with one another without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to implement a video poker game, the method comprising:
providing an electronic input device, and electronic output device, and a processing unit;
executing computer readable instructions on the processing unit which cause the following operations:
receiving a wager from a player;
dealing an initial hand of five random cards from a virtual deck face up;
randomly determining whether the game qualifies for a bonus round and indicating to the player whether the game qualifies;
enabling the player to select hold cards out of the initial hand;
replacing non-hold cards with random replacement cards from the virtual deck to form a final hand;
awarding the player any earned payout based on the final hand; and
implementing bonus round logic comprising if the final hand is a paying hand and the determining determined that the game qualifies for the bonus round then proceeding to the bonus round without requiring additional payment from the player otherwise the bonus round is not offered and the game ends.

2. The method as recited in claim 1, wherein the indicating indicates to the player that the bonus round is qualified for by displaying a message that the bonus round is qualified for.

3. The method as recited in claim 1, wherein bonus tags are associated with cards in the initial hand on a random basis.

4. The method as recited in claim 3, wherein a threshold number of the bonus tags qualifies for the bonus round.

5. The method as recited in claim 4, wherein a variable number of bonus rounds are qualified for depending on a number of bonus tags displayed.

6. The method as recited in claim 3, wherein replacing one of the cards in the initial hand with the bonus tag does not forfeit the bonus tag.

7. The method as recited in claim 6, wherein when a non-held card without a bonus tag is discarded a respective replacement card for the non-held card does not have a bonus tag.

8. The method as recited in claim 1, wherein the bonus round is a slot machine game which spins reels comprising symbols and determines a payout based on a resultant combination on the reels.

9. The method as recited in claim 1, wherein the bonus round logic further comprises that the paying hand comprises a subset of all paying hands such that some hands with payouts greater than zero are not considered the paying hand.

10. The method as recited in claim 1, wherein the bonus round logic further comprises that if the initial hand is in a set of predetermined initial hands, then the game qualifies for the bonus round.

11. A gaming apparatus, the apparatus comprising:
an electronic output device;
an electronic input device;
a payment validator configured to accept currency;
an electronic storage device;
an electronic processor connected to the electronic output device, the electronic input device, the payment validator, and configured to read and execute computer readable instructions stored on the electronic storage device;
the electronic storage device storing computer readable instructions that cause the electronic processor to:
receive a wager from a player;
deal an initial hand of five random cards from a virtual deck face up;
randomly determine whether the game qualifies for a bonus round and indicating to the player whether the game qualifies;
enable the player to select hold cards out of the initial hand;
replace non-hold cards with random replacement cards from the virtual deck to form a final hand;
award the player any earned payout based on the final hand; and
implement bonus round logic comprising if the final hand is a paying hand and the determining determined that the game qualifies for the bonus round then proceeding to the bonus round without requiring additional payment from the player otherwise the bonus round is not offered and the game ends.

12. The apparatus as recited in claim 11, wherein the computer readable instructions are programmed such that the indicate operation indicates to the player that the bonus round is qualified for by displaying a message that the bonus round is qualified for.

13. The apparatus as recited in claim 11, wherein the computer readable instructions are programmed such that bonus tags are associated with cards in the initial hand on a random basis.

14. The apparatus as recited in claim 13, wherein the computer readable instructions are programmed such that a threshold number of the bonus tags qualifies for the bonus round.

15. The apparatus as recited in claim 14, wherein the computer readable instructions are programmed such that a variable number of bonus rounds are qualified for depending on a number of bonus tags displayed.

16. The apparatus as recited in claim 13, wherein the computer readable instructions are programmed such that replacing one of the cards in the initial hand with the bonus tag does not forfeit the bonus tag.

17. The apparatus as recited in claim 16, wherein the computer readable instructions are programmed such that when a non-held card without a bonus tag is discarded a respective replacement card for the non-held card does not have a bonus tag.

18. The apparatus as recited in claim 11, wherein the computer readable instructions are programmed such that the bonus round is a slot machine game which spins reels comprising symbols and determines a payout based on a resultant combination on the reels.

19. The apparatus as recited in claim 11, wherein the computer readable instructions are programmed such that the bonus round logic further comprises that the paying hand comprises a subset of all paying hands such that some hands with payouts greater than zero are not considered the paying hand.

20. The apparatus as recited in claim 11, wherein the computer readable instructions are programmed such that the bonus round logic further comprises that if the initial hand is in a set of predetermined initial hands, then the game qualifies for the bonus round.
